(19) United States
(12) Patent Application Publication
(10) Pub. No.: US 2024/0232701 A1
(43) Pub. Date: Jul. 11, 2024

(54) EFFICIENT DRIFT DURATION PREDICTION FOR MACHINE LEARNING MODEL MANAGEMENT

(71) Applicant: Dell Products L.P., Round Rock, TX (US)

(72) Inventors: Vinicius Gottin, Rio de Janeiro (BR); Jaumir Da Silveira, JR., Rio de Janeiro (BR); Eduardo Sousa, Rio de Janeiro (BR)

(73) Assignee: Dell Products L.P., Round Rock, TX (US)

(21) Appl. No.: 18/152,588

(22) Filed: Jan. 10, 2023

(51) Int. Cl. G06N 20/00

(52) U.S. Cl. CPC G06N 20/00

(57) ABSTRACT

Techniques are disclosed for efficient drift duration prediction for machine learning model management. For example, a system can include at least one processing device including a processor coupled to a memory, the at least one processing device being configured to implement the following steps: detecting a drift in a dataset, the drift including a drift period having a start time, wherein the dataset pertains to a machine learning (ML)-based model; determining a path length for the drift period; obtaining one or more synthetic samples generated for a period following the start time using an ML-based sample synthesis model that is trained based on one or more samples observed during a period preceding the start time and on the path length for the drift period; and predicting a drift period duration for the dataset based on the synthetic samples.

### REFERENCE TO RELATED APPLICATIONS

This application is related to U.S. patent application Ser. No. 17/587,628 (the “'628 application”), entitled MACHINE LEARNING MODEL MANAGEMENT USING EDGE CONCEPT DRIFT DURATION PREDICTION, and filed Jan. 28, 2022; and U.S. patent application Ser. No. 17/363,235 (the “'235 application”), entitled ASYNCHRONOUS EDGE-CLOUD MACHINE LEARNING MODEL MANAGEMENT WITH UNSUPERVISED DRIFT DETECTION, and filed Jun. 30, 2021, the contents of each application of which are incorporated herein in their entirety for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### FIELD

Embodiments of the present invention generally relate to machine learning model management. More specifically, at least some embodiments relate to systems, hardware, software, computer-readable media, and methods for managing machine learning models for nodes in an edge environment.

### BACKGROUND

The emergence of edge computing highlights benefits of machine learning model management at the edge. The decentralization of latency-sensitive application workloads increases the benefits of efficient management and deployment of these models. Efficient management implies, beyond model training and deployment, keeping the models coherent with the statistic distribution of input data of all edge nodes. In edge-to-cloud environments, the training of models may be performed at both powerful edge nodes as well as at the cloud. The associated model inference, however, will typically be performed at the edge, due to latency constraints of time-sensitive applications. Therefore, models can benefit from efficient model management configured to consider edge nodes' opinions about model performance and determinations regarding whether a model has drifted.

### BRIEF SUMMARY

In one embodiment, a system comprises at least one processing device including a processor coupled to a memory, the at least one processing device being configured to implement the following steps: detecting a drift in a dataset, the drift including a drift period having a start time, wherein the dataset pertains to a machine learning (ML)-based model; determining a path length for the drift period; obtaining one or more synthetic samples generated for a period following the start time using an ML-based sample synthesis model that is trained based on one or more samples observed during a period preceding the start time and on the path length for the drift period; and predicting a drift period duration for the dataset based on the synthetic samples.

In some embodiments, predicting the drift period duration further comprises: determining a first confidence value based on the samples observed during the period preceding the start time and a second confidence value based on the synthetic samples generated by the sample synthesis model; and estimating the drift period duration using an ML-based drift model that is trained based on the first and second confidence values. In addition, the at least one processing device can be further configured to implement the following steps: upon observing one or more actual samples immediately following the start time: replacing a subset of the synthetic samples with the actual samples as the actual samples are observed, to define an updated sample set for the period following the start time, determining a subsequent second confidence value based on the updated sample set, and estimating an updated drift period duration for the dataset using the drift model that is iteratively retrained based on the first confidence value and on the subsequent second confidence value. In addition, the model can comprise a classifier model or a regression model. In addition, the drift model can comprise a classifier model or a regression model. In addition, the path length can be determined based on determining an aggregate path length from the observed drift periods in a training dataset. In addition, the path length can comprise a period following the start time, and the period can be determined based on a magnitude of the drift. In addition, the magnitude can measure an amount of change in a distribution underlying the dataset, and the magnitude can comprise a distance metric between a start and an end time. In addition, the at least one processing device can be further configured to implement the following step: in response to predicting the drift period duration, managing the model. In addition, managing the model can comprise: retraining the model using one or more newly observed actual samples to generate a new version of the model, and deploying the new version of the model to an edge node. In addition, the sample synthesis model can comprise an artificial neural network.

Other example embodiments include, without limitation, apparatus, systems, methods, and computer program products comprising processor-readable storage media.

Other aspects of the invention will be apparent from the following description and the appended claims.

### BRIEF DESCRIPTION OF THE SEVERAL VIEWS OF THE DRAWINGS

The foregoing summary, as well as the following detailed description of exemplary embodiments of the invention, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

To easily identify the discussion of any particular element or act, the most significant digit or digits in a reference number refer to the figure number in which that element is first introduced.

In the Drawings:

FIG. 1 illustrates aspects of an example edge computing environment, in accordance with illustrative embodiments.

FIG. 2 illustrates an aspect of an inference confidence score, in accordance with illustrative embodiments.

FIG. 3 illustrates aspects of determining a confidence threshold for a given model, in accordance with illustrative embodiments.

FIG. 4 illustrates aspects of a drift period, in accordance with illustrative embodiments.

FIG. 5 illustrates aspects of inference confidence scores, in accordance with illustrative embodiments.

FIG. 6 illustrates aspects of inference confidence values, in accordance with illustrative embodiments.

FIG. 7 illustrates aspects of an edge node, in accordance with illustrative embodiments.

FIG. 8 illustrates aspects of an inference confidence value, in accordance with illustrative embodiments.

FIG. 9 illustrates aspects of drift detection using a confidence value at the inference stage, in accordance with illustrative embodiments.

FIG. 10 illustrates aspects of drift periods in datasets, in accordance with illustrative embodiments.

FIG. 11 illustrates aspects of a confidence value during a subsequent period, in accordance with illustrative embodiments.

FIG. 12 illustrates aspects of predicting drift duration, in accordance with illustrative embodiments.

FIG. 13 illustrates aspects of drift duration prediction at an edge node, in accordance with illustrative embodiments.

FIG. 14 illustrates aspects of periods of drift change, in accordance with illustrative embodiments.

FIG. 15 illustrates an aspect of the subject matter in accordance with one embodiment.

FIG. 16 illustrates example pseudocode for determining path length, in accordance with illustrative embodiments.

FIG. 17 illustrates aspects of a training phase for a sample synthesis model, in accordance with illustrative embodiments.

FIG. 18 illustrates aspects of drift duration prediction at an edge node during an online stage, in accordance with illustrative embodiments.

FIG. 19 illustrates aspects of synthetic samples for drift duration prediction, in accordance with illustrative embodiments.

FIG. 20 illustrates aspects of drift duration prediction, in accordance with illustrative embodiments.

FIG. 21 illustrates aspects of drift duration prediction using actual observed samples, in accordance with illustrative embodiments.

FIG. 22 illustrates aspects of a method for predicting drift duration, in accordance with illustrative embodiments.

FIG. 23 illustrates aspects of a computing device or a computing system, in accordance with illustrative embodiments.

### DETAILED DESCRIPTION

Embodiments of the present invention generally relate to machine learning model management. More specifically, at least some embodiments relate to systems, hardware, software, computer-readable media, and methods for managing machine learning models for nodes in an edge environment.

The drift duration prediction techniques disclosed herein address a technical problem of performing concept drift detection over machine learning (ML)-based models in an edge computing environment.

Other drift duration prediction approaches can benefit from awaiting samples for collection for a period of time following initial detection of concept drift in a given machine learning model. Advantageously, the present drift duration prediction techniques provide a mechanism to alleviate this tendency of these other drift duration prediction approaches to wait for such samples to become available before being in a position to characterize a drift.

In example embodiments, the present drift duration prediction is configured to synthetically generate expected samples based on a predicted drift change. More particularly, example embodiments are configured to generate expected samples based on an estimated path length. The estimated path length can comprise a predicted drift magnitude change. Advantageously, the present systems and methods accordingly provide an “anytime” prediction of the duration of the drift. Some embodiments are configured to provide an immediate, coarser, prediction once the drift is detected, which is further followed by iterative—and more refined—predictions as new samples become available, as discussed in further detail herein.

### A. Introduction

The emergence of edge computing highlights the need for ML-based model management at the edge. The decentralization of latency-sensitive application workloads increases the need for efficient management and deployment of these models. Efficient management implies, beyond model training and deployment, keeping the models coherent with the statistical distribution of input data of all edge nodes. In edge-to-cloud environments the training of models may be performed at both powerful edge nodes as well as at the cloud. The model inference, however, will typically be performed at the edge, due to latency constraints of time-sensitive applications. Therefore, an efficient model management should consider edge nodes' opinions about the model local performance, so the ML model can keep relevant. The so-called “drift detection” techniques could work entirely at the edge, leveraging computation already necessary for inference and in an unsupervised fashion.

Other approaches for edge-side drift detection and drift duration prediction use aspects of the frequency and duration of concept drifts to support model management decision making-typically, to inform whether observed concept drift is frequent, cyclical or lasting enough that it requires the retraining of a new model. Such approaches can use observation of a pre-determined number of samples in order to determine the period of possible drift durations.

The present drift duration prediction uses an alternative approach that leverages a pre-trained model of drift-magnitude to generate synthetic samples that are temporarily used instead of those next samples. Advantageously, the present systems and methods are configured to provide an on-the-fly prediction of drift duration that is iteratively fine-tuned as new samples are made available.

### A.1 Overview

In edge-to-cloud management systems the training of models may typically take place on powerful edge nodes or the cloud. Model inference, however, will preferentially be performed at the edge due to latency constraints of time-sensitive applications. Efficient model management at the edge benefits from keeping the models updated, e.g., coherent with the statistic distribution of input data of all edge nodes. This is accomplished by drift detection approaches.

Other drift detection and drift duration prediction approaches leverage a method to perform unsupervised drift detection at the edge, reasoning about drift signals at the cloud to manage and update models while considering aspects of frequency and duration of the drift for decision making. The '235 application and the '628 application discuss such approaches and methods.

### A.2 Technical Problems

### A.2.1 Heterogeneity of Compute Power and Network Costs

Many of the issues that arise for the model management task at the edge relate to the need for dealing with heterogeneity and the unreliability intrinsic to the environment. The deployment of models and the relevant management tasks-among them drift detection-should be transparent to the number of edge nodes, and also be able to deal with varying levels of compute power at given edge nodes and at the central node. As such, conventionally these tasks are carried out at the cloud, avoiding the management overhead accordingly but incurring heavy network burden. Asynchronous deployment and management of models is desirable to alleviate the management overhead. Performing management tasks such as drift detection at the edge is also desirable, for minimizing said network costs.

### A.2.2 Need for Labeled Data at Inference Time in Edge Devices

Conventional drift detection and mitigation techniques assume that a system has access to model performance over time, which in turn means that labels are necessary for drift detection. Model management techniques also monitor model performance over time, with also the assumption of collecting all or a subsample of labels at inference time.

### A.2.3 Temporal Aspects of Drift Detection

The relevance of domain and context cues are appreciated in connection with drift detection-among them the aspects of duration and frequency of drift. These are related to a core concern of the model management task: to determine when it is necessary to re-train a model. Analysis of duration (and severity/magnitude of drift) are helpful to avoid re-deploying a model for a temporary drift. Analysis of frequency is helpful to avoid spurious cyclic and repeated re-training and re-deployment. Frequency is also related to temporal patterns of repetition—for example, when an edge node alternates between two “modes” of operation. In that case a model trained for one of those modes would be perceived to suffer from concept drift as the other mode occurs.

A method that allows for edge-side drift detection considering temporal aspects is helpful to improve decision making (especially regarding re-training and re-deployment of models) in model management tasks.

### B. Context for Some Example Embodiments

A suggested cloud/edge environment and management model are outlined in section B.1. In example embodiments, mechanisms of training, re-training and model confidence level determination take place in the central node and are described in section B.2. The actual drift detection and prediction that take place, in illustrative embodiments, on the edge nodes are described in section B.3.

### B.1 Edge Environment and Model Management

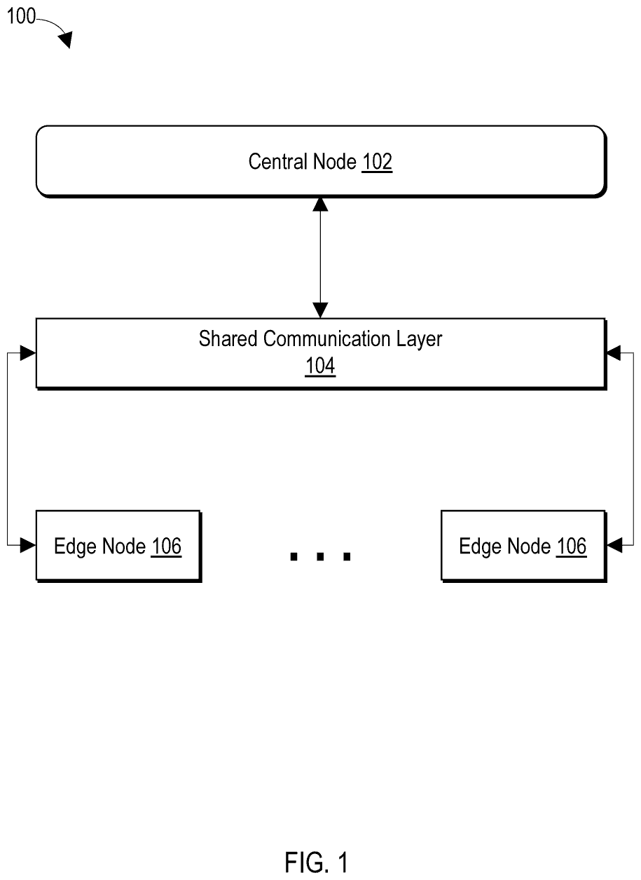

FIG. 1 illustrates an example edge computing environment, in accordance with illustrative embodiments. For example, the edge computing environment can be either in an edge-cloud or edge-core configuration. The present drift duration prediction system 100 includes a central node 102, a shared communication layer 104, and edge nodes 106.

In the central node 102, a pool of historical data representative of the domains of activity of the various edge nodes 106 is available. In example embodiments, the central node may comprise a cloud service with elastic computational resources, or a pool of static computational resources.

Each edge node 106 can be an edge computing node sometimes denoted herein by Et to denote edge node i. An edge node is configured to capture a continuous or sporadic stream of data, sometimes denoted herein by Sᵢ. The edge node can have associated sensors configured to obtain the stream of data Sᵢ. These data may be locally stored at the edge node, for a variable period of time, in a local data pool sometimes denoted herein by Lⁱ.

The present disclosure discusses a single model for a particular task at each node for case of discussion, for example, models M⁰, M¹. It is appreciated that in practical applications each edge node may be configured to use multiple ML models, without departing from the scope of the invention. The present disclosure further presumes a homogeneous edge environment with respect to the data streams, for case of discussion. That is, the streams S₀, S₁, . . . , Sᵢ, . . . are expected to conform to a same underlying distribution at a given time, such that distribution changes detected in one stream (which can possibly be characterized as drift) are expected to be perceived in all others roughly at the same time, possibly with some delay. Thus, “updates” of all the models of all edge nodes can be enacted in response to drift perceived in any or all of the data streams, depending on domain-dependent decision making.

The shared communication layer 104 facilitates communication between the central node 102 and the edge nodes 106. Example embodiments of the shared communication layer include a software object configured to perform communication between the central node and edge nodes, for example in an indirect and asynchronous fashion. The shared communication layer further comprises a storage area where messages and data can be stored and discarded. The shared communication layer manages this storage area by:
accepting and executing requests for storing, updating and deleting messages in the storage area,
accepting and executing requests to store published models by the central node to be consumed by the edge nodes, and
accepting and executing requests to store data sample batches from the edge nodes to be used for retraining by the central node.

Messages refer to a specific short sequence of bytes that signal system states understood by both the central node 102 and the edge nodes 106. The fact that the shared communication layer 104 can be a middle software layer used by the central node and edge nodes to communicate gives the benefit of asynchronism and independence of implementation between central nodes and edge nodes. As used herein, mentions of, for example, “the central node sends a signal to the edge nodes” or the “edge nodes signal the central node,” signals refer to messages sent by the emitter to the shared communication layer and received by the receiver(s), such as by polling the layer at particular times and situations according to a corresponding messaging algorithm as appropriate.

### B.2 Offline Stage

### B.2.1 Inference Confidence Levels

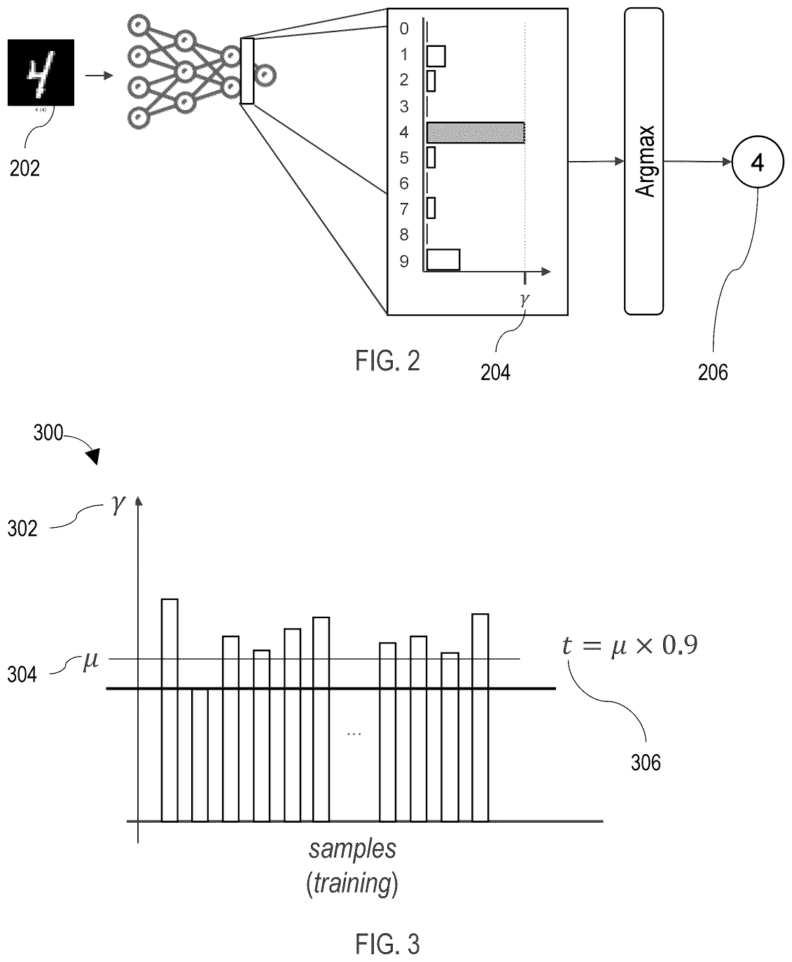

FIG. 2 illustrates an example inference confidence score 204, in accordance with illustrative embodiments. More particularly, FIG. 2 illustrates an example inspection of inference confidence in the pre-argmax layer of a classification model. The first stage of detecting drift relates to the collection of confidence levels in the inferences over the training set. After the model is initially trained on the central node, the training set is used again to obtain the values of the softmax layer for each sample. The aggregated values of the softmax layer of the sample set are the confidence levels. FIG. 2 illustrates inspection of the inference confidence in the pre-argmax layer of a classification model, performed at training time, for a given sample 202.

In the example shown in FIG. 2, the resulting confidence score 204 γ of the inference 206 (e.g., the class with higher probability) of a sample (e.g., for the MNIST handwritten digit classification problem) is obtained. An aggregate statistic u of the confidence over the complete training dataset, sometimes referred to herein as a “confidence value,” is updated accordingly. In example embodiments, the confidence value u may comprise the mean prediction confidence of all inferences. The mean may be updated on a sample-by-sample basis if the number of samples already considered, k, is kept in memory and incremented accordingly. For example, for each sample,

$$μ ← μ + \frac{γ}{k}$$

and k←k+1 when k>0; μ←γ otherwise.

The process of obtaining the inference confidence score 204 for each sample 202 and updating an aggregate statistic u may be performed online with respect to training, as batches of samples are processed, or offline, after a resulting model is obtained. In either case—and especially the latter, since the model is already converged—it may be advantageous to consider only the confidence levels in inferences that are correct (e.g., that result in the prediction of the true label for the sample). If the overall error of the model is very small this may not significantly impact the statistic u; however, for models with lower accuracy, considering only the true predictions will typically result in a significantly higher value for the inference confidences (i.e., the model will likely assign higher confidences to the inferences of easier cases, that it is able to correctly classify or predict).

FIG. 3 illustrates an example determination 300 of a confidence threshold 306 for a given ML model, in accordance with illustrative embodiments. The resulting inference confidence values 304 μ are used to derive the confidence threshold t for the model.

This threshold 306 represents an aggregate confidence of the model on the inferences it performed on the training dataset. In example embodiments, if the confidence statistic is the mean of the confidence scores 302 of the samples, the threshold may be determined as a fraction (or factor) of the mean. Alternatively, the threshold may be determined as the mean adjusted by a constant factor. FIG. 3 illustrates determination of the threshold as a predetermined fraction (e.g., 0.9) of the mean of the confidence scores of the inference over the training samples.

The resulting threshold 306 is propagated to the edge nodes for the edge-side inference stage. It is appreciated that while the discussion above involves a neural network classification model for ease of discussion, the same methodology can be applied for regression neural networks, for example by using variational neural networks and using the standard deviation of the prediction as the confidence of a sample.

In some embodiments, the threshold 306 t should be adjusted down so that the method avoids excessive false positives. Section B.2.2 discusses such an example adjustment at the end.

### B.2.2 Offline Stage of Drift Duration Prediction Based on Class-Specific Confidences at Detected Drift Intervals

The disclosure below presumes one or more labeled datasets D comprising samples dₜ collected from data streams, for ease of discussion. Typically, each dataset D originates from an edge node's stream (e.g., streams S₀, S₁, . . . as shown in FIG. 7). The historical dataset in the central node (FIG. 1) thus comprises the set of datasets D available. The present disclosure further presumes for ease of discussion that each dataset D is ordered by time of collection t, such that sample dₜ precedes dₜ₊₁, for any 0≤t≤z. For the present discussion, each dataset D may be considered to start at time 0 individually (e.g., the oldest sample in each dataset D is assigned a timestamp of zero) even if the datasets are in reality unaligned. It will be also appreciated that not all datasets may contain samples for every timestamp, and some datasets may contain more than one sample for a single timestamp. Neither case deeply affects the present drift duration prediction techniques, and the discussion below presumes the straightforward case for ease of explanation. The present disclosure further discusses impacts of missing or overlapping samples when applicable, as well.

Each of the samples in d E D pertains to a class in the set of classes [symbol] ={C⁰, C¹, . . . , C²} considered by the domain. As discussed in connection with FIG. 1, and also as in the approach described in section B.2.1, the present systems and methods are configured to obtain a classifier model M that considers that set of classes. The model is deployed to the edge nodes in the domain. The model M can be obtained via any conventional machine learning process, without departing from the scope of the invention. For ease of discourse the present disclosure presumes a similar training approach as the one described in section B.2.1, where the dataset D comprises (part of) the training data for the model.

Upon inspection, it is possible to obtain the inference confidence over sample d by model M.

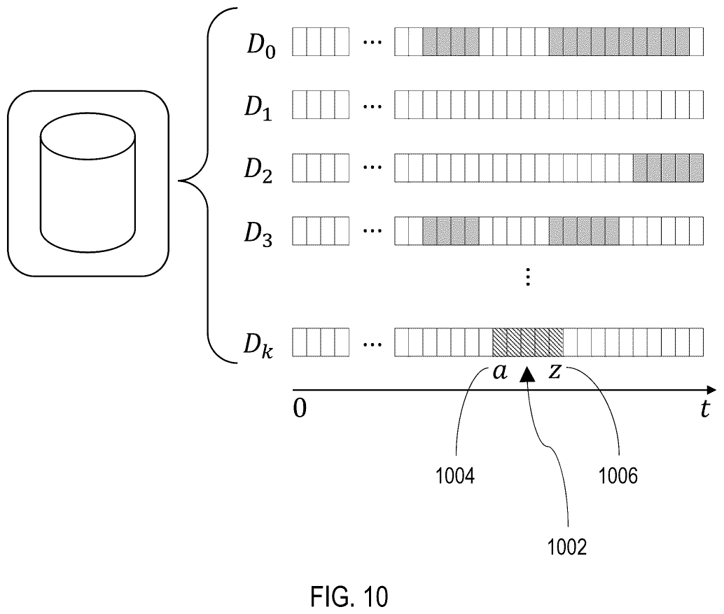

For a labeled dataset D, the present systems and methods are configured to identify periods of concept drift. Concept drift is discussed further in G. I. Webb, R. Hyde, H. Cao, et al., “Characterizing Concept Drift,” Data Mining and Knowledge Discovery, vol. 30, no. 4, pp. 964-994 (2016), the contents of which are incorporated by reference herein in their entirety for all purposes. It will be appreciated that any approach for drift detection may be used for identifying periods of concept drift, without departing from the scope of the invention. The notation [a, z] represents a period of time between and including a and z. This drift duration period is discussed further below in connection with FIG. 10.

It will be appreciated that in actual environments the datasets may comprise large numbers of samples. In the discussion that follows, the present disclosure adopts a representation of a very small number of samples for ease of explanation.

Let [symbol] be a set of tuples (a, z) determining, respectively, the starting time a and ending time z of a drift duration s=z−a. It is appreciated that each sample dₜ∈D can be determined to belong to a period of drift by checking whether t falls within a period of concept drift [a, z]. The present drift duration prediction is configured to leverage this property.

For the determination of periods of concept drift, a few observations apply. First, “open ended” drift periods are not considered. For example, with reference to FIG. 10, at timestamp t the dataset D₂ (presumed to originate from the stream S₂) is illustrated being under ongoing drift. Since an end timestamp z cannot be determined, the present drift duration prediction opts to disregard that period of drift.

Also, particularly during drift periods there may be missing samples for timestamps. This is due to the fact that, upon identifying drift, edge nodes may typically reduce the sampling interval and the interval in which they apply their model for inference. The present drift duration prediction presumes that the first sample after a period of drift determines that the previous sample represents the end of the drift period. This choice tends to under-estimate the duration s of drift periods. In alternative embodiments, different choices can be made with little effect on the overall approach.

The confidence method described in section B.2.1 can be leveraged for drift detection as used herein because the confidence method collects the inference confidence score of each sample in the training dataset-which confidence scores can be leveraged by the present drift duration prediction techniques as well. If the inference confidence scores are already obtained as part of the concept drift period detection, then advantageously the confidence scores can be reused by the present drift duration prediction, as discussed in further detail below.

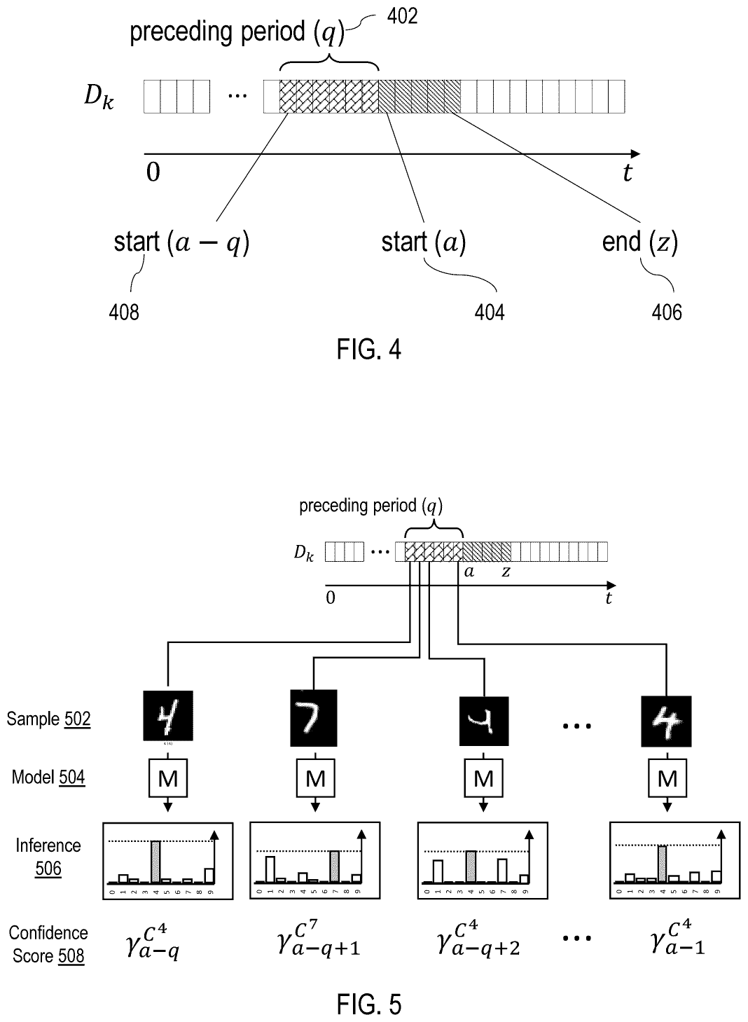

FIG. 4 illustrates an example drift period, in accordance with illustrative embodiments. Particularly, FIG. 4 illustrates a representation for dataset Dₖ of a preceding period 402, in accordance with illustrative embodiments. The preceding period represents the period immediately preceding a drift period [a, z], as determined by a parameter q. The drift period has a start time 404 a and an end time 406 z. First, the present drift duration prediction obtains inference confidence scores for the samples in the period [a-q, a], e.g., the period having a start time 408 denoted by a-q and an end time 404 denoted by a, where q is a parameter reflecting the maximum number of samples preceding a drift period to be considered. Formally, these samples comprise a set D_{q}={dₜ|t<aΛt≥(a-q)}.

The parameter q can be typically determined with respect to the time taken to collect that many samples. Phrased differently, the parameter q can be predetermined to correspond to sufficient time for training and deploying a new version of model M to a given edge node.

FIG. 5 illustrates an example confidence score 508, in accordance with illustrative embodiments. For each sample 502 dg E Da, the present drift duration prediction is configured to obtain an inference confidence score 508 for the predicted class(es) by a model 504 M. In example embodiments, the present systems and methods are configured to leverage the drift detection approach described in section B.2.1-which advantageously is configured already to provide the inference confidence scores of the samples. If other drift detection approaches are used to determine the period(s) [a, z]∈ [symbol] , it is appreciated that the inference confidence score of d_{q} would be computed from scratch (for example, by performing an inference 506 and capturing intermediate information within the model), without departing from the scope of the invention.

More particularly, FIG. 5 illustrates an example determination of an inference confidence score 508 for predicted classes from the samples 502 in the preceding period q in the interval [a-q, a] of a dataset Dₖ. In particular, FIG. 5 shows three examples of a predicted class C⁴ (corresponding to the class of digit ‘4’ in the dataset) and one example of a predicted class C⁷ (corresponding to the class of digit ‘7’ in the dataset).

The present drift duration prediction is configured to compute an aggregate statistic of the inference confidence scores for all correctly classified samples in D_{q}. These statistics are aggregated by the inferred class [symbol] ={C⁰, C¹, . . . C²}. Example embodiments of this aggregate statistic may comprise the mean, but in alternative embodiments other kinds of applicable statistics may be adopted. The present disclosure refers to these statistics as μ_{Q}. It will be appreciated that that this is a simplified notation for case of discussion herein, assuming the discussion focuses on a particular drift period. More particularly, a more fullsome notation could further include, for example, an index for the dataset, and an index of the drift period in the set [symbol] , as well as in that dataset.

FIG. 5 illustrates only a few samples 502 of predicted digit ‘4’ and one case of a predicted digit ‘7’ in the period [a-q, a] preceding the drift, for ease of discussion and due to the restricted size of the example depicted. The confidence scores can be labeled using the timestamp. (It is appreciated, again, that this represents a simplified notation reflecting the fact that the present disclosure focuses on a single drift period for ease of explanation.) It is additionally appreciated that in actual environments this period may comprise many (e.g., potentially many thousands of) samples and each predicted class would relate to many inference confidence scores.

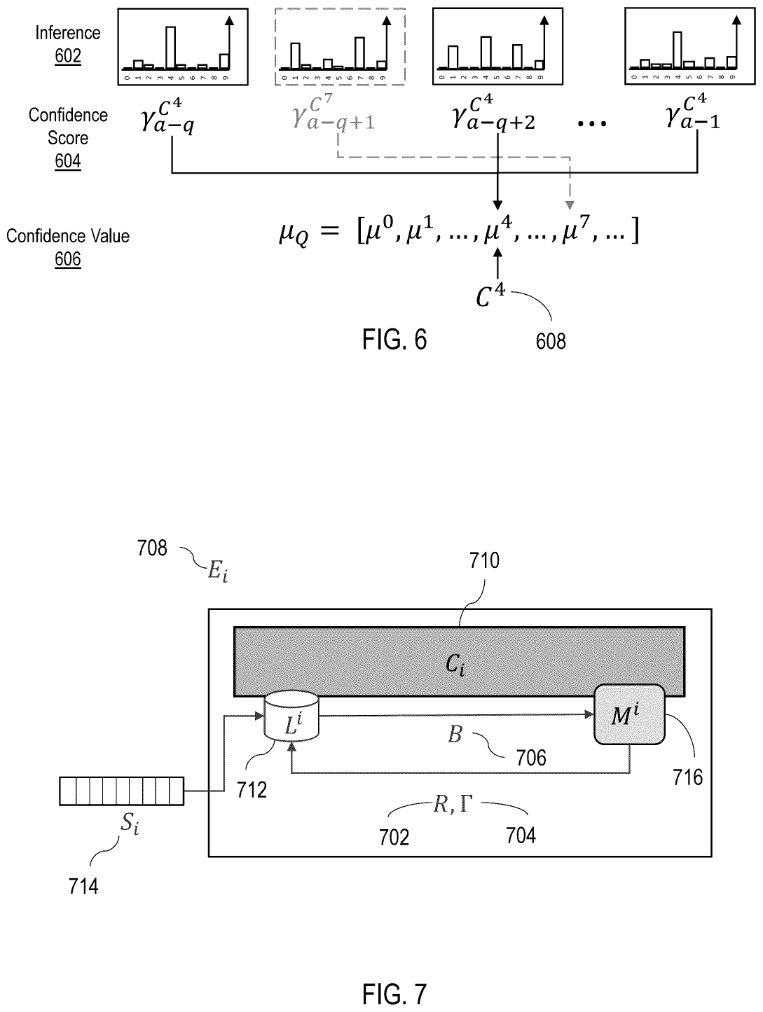

FIG. 6 illustrates an example confidence value 606, in accordance with illustrative embodiments. The confidence value 606 μ_{Q} illustrates the computed aggregate score (e.g., a median) for inference scores of predicted class C⁴, following the example discussed in connection with FIG. 5. The confidence value represents the aggregate statistics μ_{Q} of the inference scores per-class.

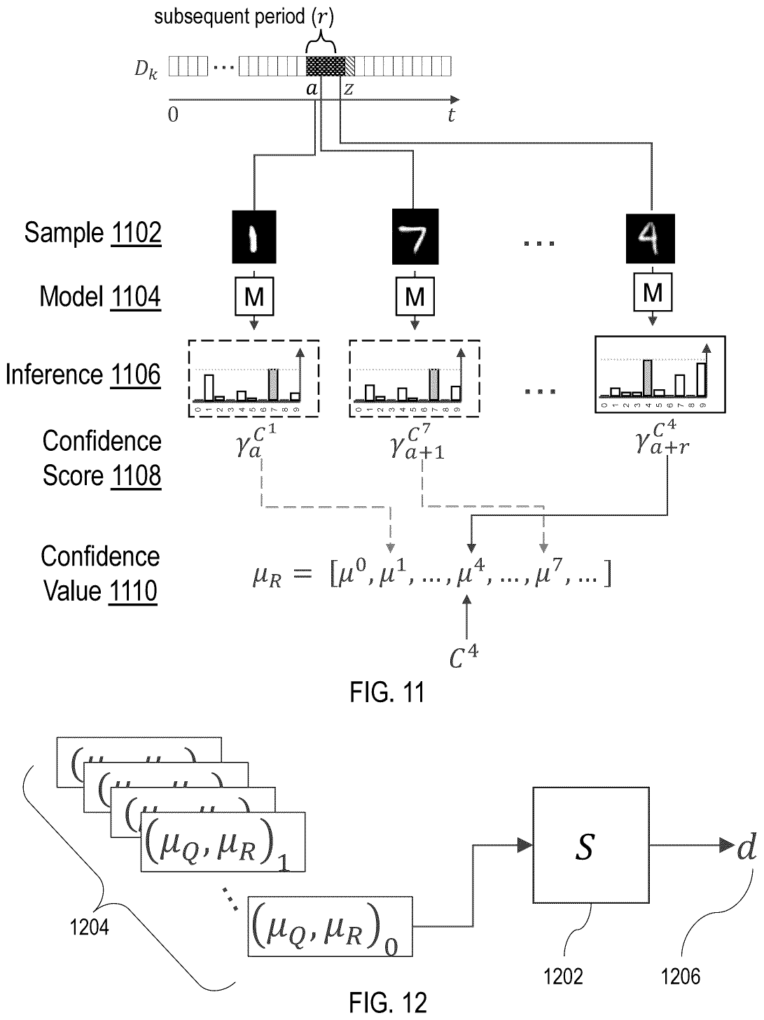

The present drift duration prediction is configured similarly, to compute aggregate statistic(s) of the inference confidence scores for the samples during the immediate start of the drift period [a, a+r], with r<s being a parameter representing the number of samples during the immediate start of the drift period to consider (and recalling that s represents the duration of the drift period). Formally, these samples comprise a set Dᵣ={dᵣ|t≥aΛt≤a+r}, with resulting statistics UR, as discussed in further detail in connection with FIG. 11.

It is appreciated that the number of samples r should be selected to be small, to allow for faster determination of a drift period duration, but large enough to be representative of cases of classes in the domain. Any suitable method can be used for determining an appropriate value for r, without departing from the scope of the invention. In the example discussed herein, the illustrated number of samples determined by r is exceedingly small relative to practical applications, for ease of explanation.

The last part of the offline stage is to obtain a drift model S. The drift model relates the inference confidence score statistics of the periods preceding a drift μ_{Q} and immediately following a drift μ_{R} to an estimate of the duration of the drift period s. The present disclosure refers to this drift model as S, to distinguish it from the model M of the domain (e.g., a classifier model).

It is appreciated that a significant number of drift periods may be available (to provide sufficient data for training of the drift model S), given that model M is deployed to an edge environment comprising a huge number of nodes. In an embodiment in which each edge node is configured to perform drift detection (for example using the approach described in section B.2.1) a significant amount of drift periods may be detected. Hence, there may typically be many values for (μ_{Q}, H_{R}, S) available: such as one triple for each drift period in any dataset available.

In example embodiments, with a large enough edge environment comprising many (e.g., possibly thousands or millions of) edge nodes, there may be enough data to allow for the training of a machine learned model, such as neural network, that relates μ_{Q}, μ_{R}→s′.

In alternate embodiments, and especially if the number of triples available is small, the drift model S may comprise a regression model relating the per-class difference between the inference confidence statistics μ_{R}-μ_{Q} and the duration of the drift period s. It is also appreciated that this embodiment may be preferable in edge environments in which the nodes have limited processing power and storage capability, since the drift model S is deployed to the edge nodes alongside M. Other kinds of models can be applied as appropriate without departing from the scope of the invention, as discussed further in connection with FIG. 12.

### B.3 Edge-Side Inference Stage

In example embodiments, once the various models are trained, then the central node is configured to deploy the models to each edge node. The edge nodes are configured to detect drift in the deployed models during the inference stage.

### B.3.1 Edge-Side Drift Detection

The drift detection mechanism takes place at inference time on each edge node. For drift detection the edge node is configured to inspect the model in a similar way as in the training stage.

FIG. 7 illustrates an example edge node, in accordance with illustrative embodiments. Particularly, FIG. 7 illustrates obtaining example inference results 702 and confidence levels 704 over a batch 706. More particularly, at edge node 708 Eᵢ having an edge controller 710 Cᵢ, a batch B of samples is composed from local data 712 Lⁱ that corresponds to samples from the local stream 714 Sᵢ. The batch B is provided as input to the model 716 Mⁱ for inference. The results 702, 704 R={r₀, . . . , r_{|B|}} and Γ={γ₀, . . . , γ_{|B|}} are also stored. In particular, these results comprise the results 702 rⱼ for each sample j in B (e.g., the predicted classes) and the corresponding confidence 704 of the model in that result γⱼ (e.g., the confidence of the model in the predicted class).

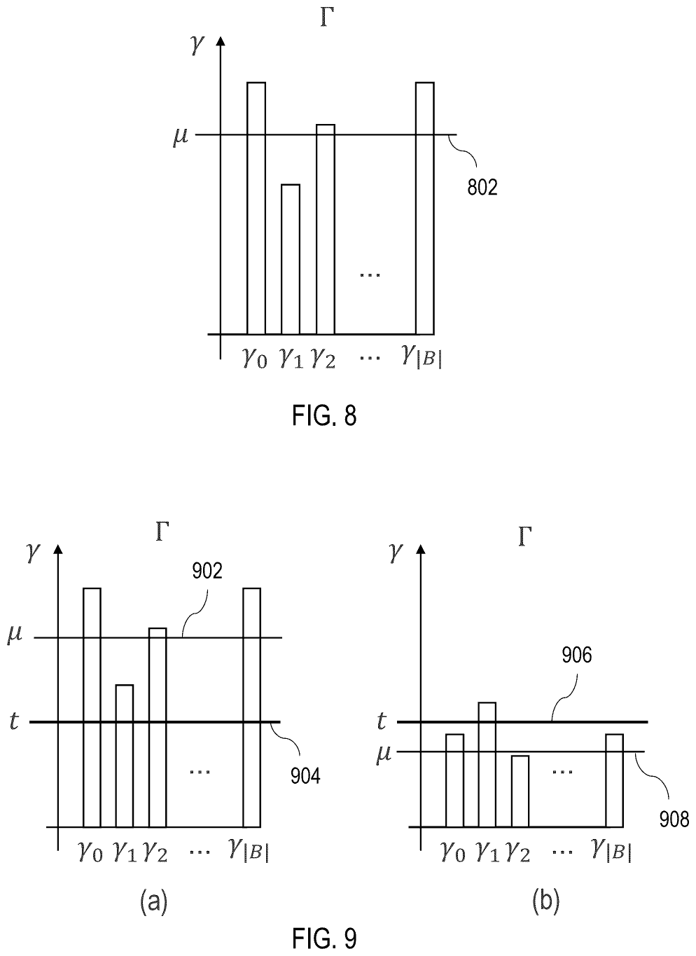

FIG. 8 illustrates an example confidence value 802, in accordance with illustrative embodiments. At the inference stage the inference confidence scores γᵢ of each sample in i={0,1,2, . . . , B} are obtained in a similar way as the example method used to obtain the respective confidence scores at the training stage. Also, in a similar way as at the training stage, these per-sample confidence scores are aggregated into an inference confidence value 802, which can be a representative statistic. In example embodiments, the confidence value comprises the mean (similar to the example confidence value 304 (FIG. 3)) of all confidence values in batches B.

FIG. 9 illustrates example drift detection using the confidence value 902 at the inference stage, in accordance with illustrative embodiments. More particularly, FIG. 9 illustrates example comparisons of the mean confidence in batch inference to the threshold determined at the training stage. The next step in inference-stage drift detection is to compare the aggregated inference confidence value 902 μ.

Intuitively, the present drift duration prediction leverages an insight that if the model is sufficiently confident in its predictions, at least to a similar level as in the training, then the distributions of the stream data at the edges are likely to be similar to those of the training data. Acknowledging that this presumption is not guaranteed, however in practice it reflects a reasonable heuristic. Conversely, the present drift duration prediction considers the model not being sufficiently confident in its predictions to be a reasonable proxy for the presence of concept drift in the stream data.

It is appreciated that in these example embodiments no label is required since the present drift duration prediction is configured to inspect the inference confidence in the model itself. This is one reason why the threshold t can be selected to be a value lower than the average u found at training time. In contrast if the threshold t is selected to be overly high, then a batch of relatively ‘hard’ samples will indicate a drift, which would not be desirable. Instead, with a lower t, the present drift duration prediction operates to detect or identify a drift only when a batch presents a significantly lower confidence than the global confidence experienced by the model during training.

### B.3.2 Online Stage of Drift Duration Prediction

Following the offline stage, the drift model S is deployed to the edge nodes along with the model M. As each edge node consumes new samples from its own data stream and performs inference (via model M), an approach for edge-side drift detection may be applied. In example embodiments, the edge-side drift detection approach described in the '235 application is applied, particularly regarding the edge-side inference stage (as discussed in section B.3.1). In alternative embodiments, other drift detection approaches may be applied as appropriate without departing from the scope of the invention. The edge-side drift detection discussed in section B.3.1 and in the '235 application has the advantage of relying on inference confidence scores, which are further leveraged as discussed in further detail below. Accordingly, if the selected drift detection approach is already configured to determine and collect such inference confidence scores, the confidence scores can be reused rather than recalculated for the present drift duration prediction. That said, it is appreciated that other kinds of edge-side drift detection approaches can be used as appropriate without departing from the scope of the invention.

Upon identifying a possible drift period (which can use any appropriate drift detection method, as discussed), online drift duration prediction techniques are generally configured to compute per-class aggregate statistics μ′_{Q} of inference confidence scores of the most recent q samples in that edge node's stream. This (including the determination of parameter q) is performed in a similar fashion as in the offline stage (see section B.2.2). (The notation adopted herein disregards, for example, the indexing of a dataset and drift period for ease of explanation, as previously discussed.)

Online drift duration prediction techniques are then configured to obtain the next samples up to r timestamps, obtaining their respective inference confidence scores via model M. (These scores will likely be unavailable, since the model is considered drifted and the inference via M is not already performed, as was the case for the q samples before the drift detection signal). The per-class confidence statistics μ′_{R} are computed, also similarly as described in the offline stage (and again adopting the same simplified notation that disregards, for example, the indexing of a dataset and drift period for ease of discussion).

With μ′_{R} and μ′_{Q} in hand at the edge node, the present online drift duration prediction uses the drift model S to determine a predicted drift duration s′ to the current period of detected drift. In embodiments where the drift model S comprises a regression model, then the difference μ′_{R}-μ′_{Q} may be computed beforehand to be provided to the drift model as input.

### B.4 Edge-Side Drift Detection

Edge-side drift detection uses aspects of the frequency and duration of detected drift to support model management decision making, for example, informing whether the observed concept drift is frequent, cyclical, or lasting enough that it warrants the retraining of a new model.

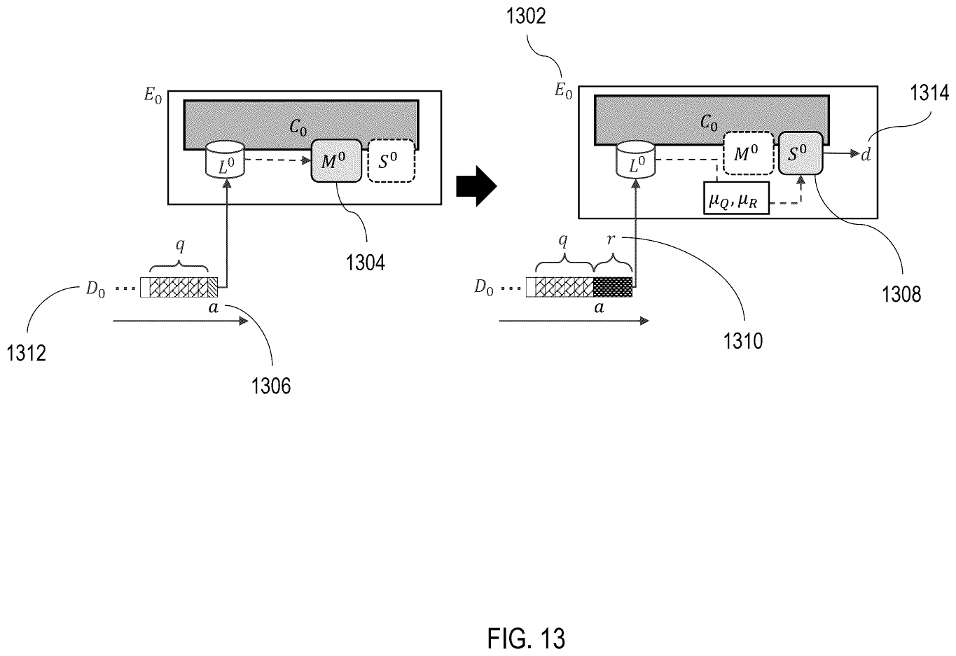

A summary of the drift detection approach discussed above is as follows:
1. When training a domain-specific model M to be deployed at the edge node(s):
   a. Identifying start and end of drift periods in the training datasets, using a drift detection mechanism (FIG. 10)
   b. Obtaining of the per-class inference confidences in the periods q immediately preceding and r immediately following the start of the drift periods a (FIG. 11), and
   c. Training a drift model S that relates an expected confidence in the inference of samples of each class before and after a drift starts, to a prediction of the duration of the drift period (FIG. 12, section B.2.2), and
2. Deploying drift model S in tandem with model M to the edge nodes and, upon identifying possible concept drift at instant a (FIG. 13):
   a. Obtaining the per-class inference confidences of the samples in a period q preceding a, and
   b. Waiting for r samples, and obtaining the per-class inference confidence of those r samples following a.

FIG. 10 illustrates example drift periods in datasets, in accordance with illustrative embodiments. As summarized in step 1.a above, the drift period 1002 can include a start time 1004 a and an end time 1006 z for a dataset Dₖ. Drift periods in other datasets D₀, D₁, D₂, D₃, . . . are also shown for illustrative purposes.

FIG. 11 illustrates an example confidence value 1110 during a subsequent period r, in accordance with illustrative embodiments. In particular as summarized in step 1.b above, FIG. 11 illustrates an example computation of the confidence value UR based on the confidence scores 1108 of the predicted classes in the period r immediately following the start a of the concept drift period, as determined by the parameter r. Computation of the confidence value representative statistic for class C⁴ is highlighted. Computations of confidence values for classes C¹ and C⁷ are also shown based on respective confidence scores determined using the inferences 1106 computed via the models 1104 based on the samples 1102.

FIG. 12 illustrates an example prediction of drift duration 1206, in accordance with illustrative embodiments. More particularly as summarized in step 1.c above, FIG. 12 illustrates an example representation of drift model 1202 S relating aggregate statistics 1204 of the per-class inference confidences μ_{Q} and μ_{R} to an expected drift period duration d.

FIG. 13 illustrates an example drift duration prediction at an edge node 1302 E₀, in accordance with illustrative embodiments. It is noted in connection with step 2 above that the drift duration prediction approach summarized above presumes that upon determining drift, a predetermined number 1310 of samples r are collected and used as part of input to a drift model 1308 S configured to predict the duration 1314 d of the drift period. More particularly, a deployed drift model S requires r samples 1310 from the stream 1312 D₀ after a drift indication at instant 1306 a.

In FIG. 13, the domain-specific model 1304 M⁰ is used as normal until instant 1306 a in which a drift detection mechanism indicates probable concept drift (section B.3.1) (FIG. 13, left). Then, drift model 1308 S⁰ is invoked to predict how long the drift will last-so that model management decisions can be made (such as “should a new model M′ be deployed to replace M⁰?”). However, because the drift model S requires r samples after the drift, the above drift duration prediction technique has to wait for those samples to be made available (FIG. 13, right). Meanwhile, the edge node 1302 E⁰ cannot fully operate during such subsequent period from [a, a+r] since the model M⁰ is considered unreliable.

If r is too small, then the accuracy of the drift model 1308 S can also become impaired since the drift model must rely mainly on normative data q before the drift happens. On the other hand, larger values of r can result in undesired longer periods of idleness for the drift model S as it waits for the samples to become available. This diminishes the advantages of the duration prediction for decision making, to a point (for example, with excessively large values of r) where prediction of the duration only becomes available as the drift period ends.

### C. Further Aspects of Some Example Embodiments

The present drift duration prediction techniques provide a mechanism to alleviate the tendency of other drift duration prediction approaches to wait for r samples to become available before being in a position to characterize a drift.

In example embodiments, the present drift duration prediction is configured to synthetically generate expected samples based on a predicted drift change. Specifically, example embodiments are configured to generate expected samples based on a predicted drift magnitude change. Advantageously, the present systems and methods accordingly provide an anytime prediction of the duration of the drift. More particularly, example embodiments are configured to provide an immediate, coarser, prediction once the drift is detected, which is further followed by iterative—and more refined-predictions as new samples become available, as discussed in further detail herein.

### C.2.1 Offline Stage

In addition to identifying the start and ending of drift periods a and z (as discussed in connection with FIG. 10), an offline stage further includes computing a magnitude and path length of the drift.
A magnitude of a concept drift operates to quantify how much the underlying distribution of the data features changes between two given moments. The definition of the magnitude of concept drift can be highly dependent on the domain of the data. In example embodiments, the magnitude can be expressed generally as a distance function

$$Dist ( t , t + m )$$

between instants t and t+m that yields a distance metric. Advantageously the distance metric can have desirable intuitive properties of distances. Embodiments of the present drift duration prediction can use, for example, Hellinger Distance, KL divergence, or other distributional divergence metrics as appropriate, without departing from the scope of the invention.
The path length refers to the cumulative deviation observed during the period of concept change. In example embodiments, the path length can be expressed as

$$P a t h L e {n}_{t , u} = {lim}_{n \to ∞} {\sum }_{k = 0}^{n - 1} ( a + \frac{k}{n} ( u - a ) , t + \frac{k + 1}{n} ( u - a ) )$$

where a denotes the start of the drift period and u denotes the final point of time in which a concept drift event builds; and n is the number of observable time increments between those points in time. In example embodiments, the time increments are represented by the samples of the drift period, as discussed in further detail below.

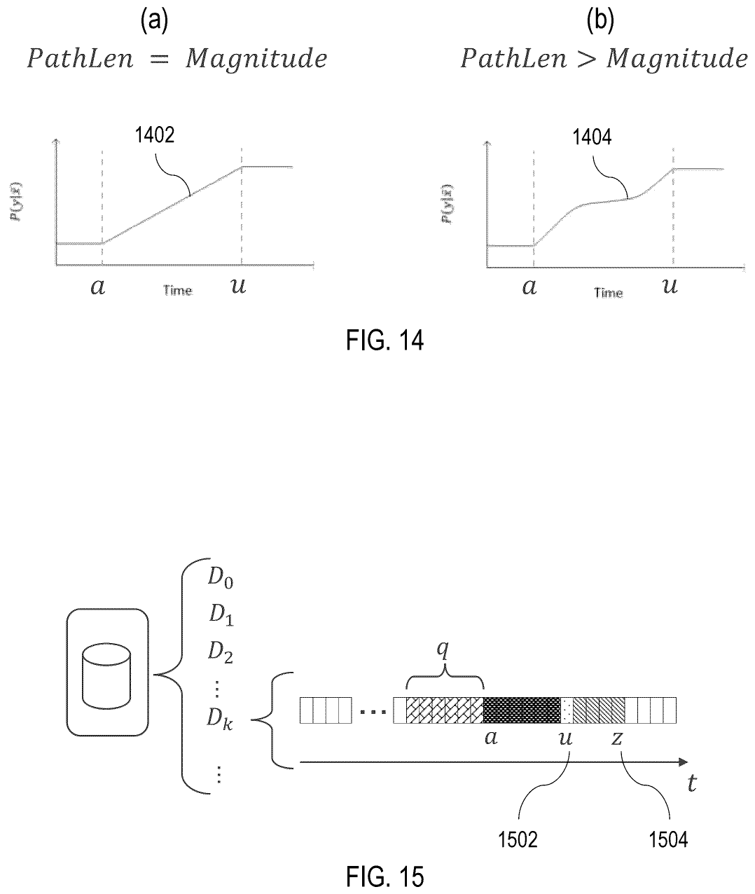

FIG. 14 illustrates example periods of drift change, in accordance with illustrative embodiments. The concepts of magnitude and path length are linked. In particular, FIG. 14(a) and FIG. 14(b) illustrate two scenarios of building concept drift. Building concept drift refers to the portion of a drift duration in which the divergence between the initial, normative, distribution and the final, drifted, distribution change. For example, the two periods of change in FIG. 14(a) and FIG. 14(b) exhibit the same magnitude of drift built from time a to time u. However, a comparison of the scenario in FIG. 14(b) exhibits greater path length 1404 relative to the path length 1402.

FIG. 15 illustrates an example drift period, in accordance with illustrative embodiments. Particularly, FIG. 15 illustrates an example final time in which drift builds. FIG. 15 illustrates an example identification of time u in a training dataset Dₖ. In exemplary embodiments it is appreciated that u, denoting the instant 1502 at which drift stops building, is considered to be different from the instant 1504 z, which denotes the end of the drift period.

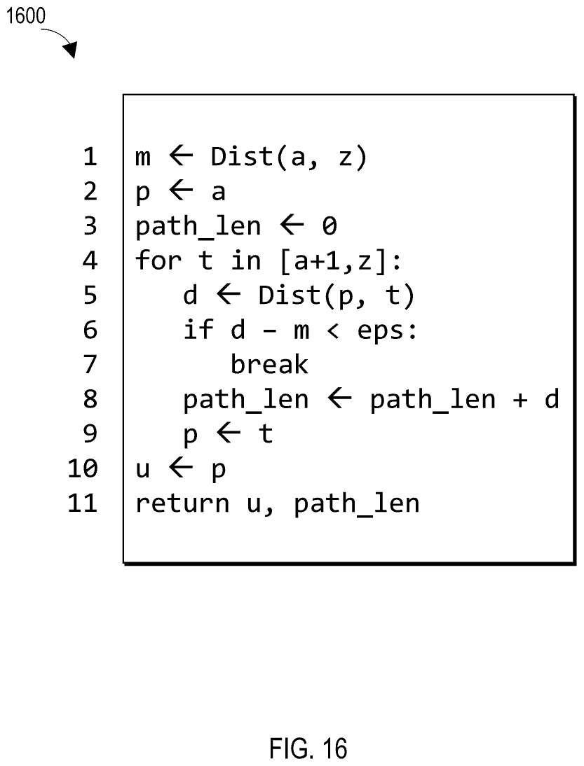

FIG. 16 illustrates example pseudocode for determining path length, in accordance with illustrative embodiments. Specifically, FIG. 16 illustrates a heuristic algorithm 1600 for path length determination of a given drift.

The algorithm 1600 is configured to iterate through the samples and compute a cumulative deviation given an appropriate Dist function; stopping upon identifying that the maximum deviation (assumed to hold to the end of the drift period) is reached. The illustrated algorithm assumes that the concept drift magnitude does not substantially increase above the final divergence (where eps represents an arbitrarily small non-negative value). If that assumption does not hold in the given domain, it is appreciated that the algorithm can be updated appropriately, without departing from the scope of the invention.

The algorithm also determines the path length as the final result of that cumulative deviation. Using u, the magnitude of the drift period can be determined using the given Dist function as Dist (a, u).

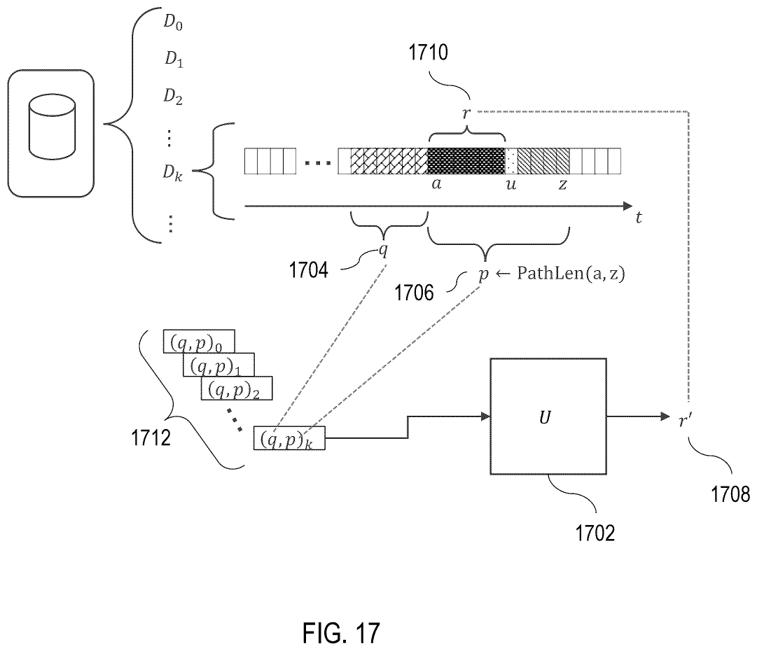

FIG. 17 illustrates an example training phase of a sample synthesis model 1702 U, in accordance with illustrative embodiments. Specifically, FIG. 17 illustrates a training of the sample synthesis model U relating samples 1704 q and a path length 1706 p to a set of synthetic samples 1708 r′. The computation of the magnitude and path length can be exhaustively performed over all drift periods in the available training datasets. With each magnitude and path length in hand, the present drift duration prediction is configured to select the samples 1704 preceding the drift q and estimated path length 1706 p as input 1712 to the sample synthesis model U, and the actual samples 1710 following the drift r as the target output 1708 of the sample synthesis model.

Example embodiments of the sample synthesis model 1702 U can comprise an artificial neural network. If samples are not periodically observed (e.g., if the number of samples observed in q or r is variable from period to period), then a model capable of processing variable length sequences of inputs and outputs may be used instead, such as (but not limited to) Recurrent Neural Networks. In alternative embodiments, the sample synthesis model may include any supervised learning method appropriate for the given domain, without departing from the scope of the invention. In further embodiments, the sample synthesis model may consider as input the feature importance in the domain.

Accordingly the obtained sample synthesis model 1702 U is configured, in an online fashion, to predict the next r′ samples of an observed data stream under drift, given an estimation of the path length of that drift.

### C.2.2 Online Stage

While section C.2.1 described configuration of the sample synthesis model during an offline stage, the disclosure below describes operation of the sample synthesis model U during an online stage of the edge nodes.

In example embodiments, the central node deploys the sample synthesis model U to the edge nodes. The sample synthesis model can then be used in conjunction with the drift detection and drift duration prediction approaches described in section B. As each edge node consumes new samples from its own data stream and performs inference (via the domain-application model M), an approach for edge-side drift detection such as the one discussed in section B and described in the '235 application may be applied.

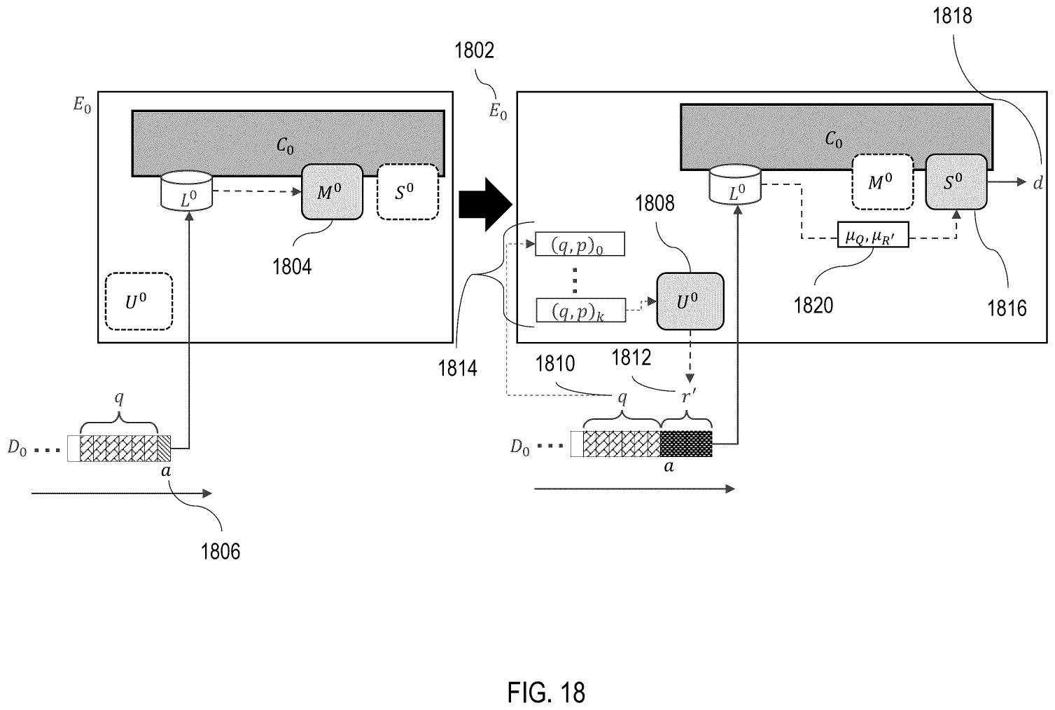

FIG. 18 illustrates an example drift duration prediction at an edge node 1802 during an online stage, in accordance with illustrative embodiments. In FIG. 18, the domain-specific model 1804 M⁰ is used as normal until instant 1806 a in which a drift detection mechanism indicates probable concept drift (section B.3.1) (FIG. 18, left). Upon detecting potential drift at instant a, a sample synthesis model 1808 U can be trained that relates samples 1810 q and an estimated path length p to a set of synthetic samples 1812 r′. The present drift duration prediction is configured to select the samples 1810 preceding the drift q and the estimated path length p as input 1814 to the sample synthesis model U, which is configured to generate the set of synthetic samples 1812 r′. With the q and r′ samples in hand, the drift model 1816 S can be used to predict an estimated initial drift duration 1818 d. This prediction includes leveraging the statistics 1820 that include the inference confidence values μ_{R′} of the set of synthetic samples r′.

Upon identifying a possible drift period, the present systems and methods are configured to obtain a prediction of the likely duration 1818 of the drift period. To that end the drift model 1816 S can be applied, as discussed in section B and described in the '628 application. However, as discussed in section B.4, the drift model uses q samples prior to the drift detection and r samples following the drift detection. It is recognized that those r samples may not necessarily be readily available in some circumstances.

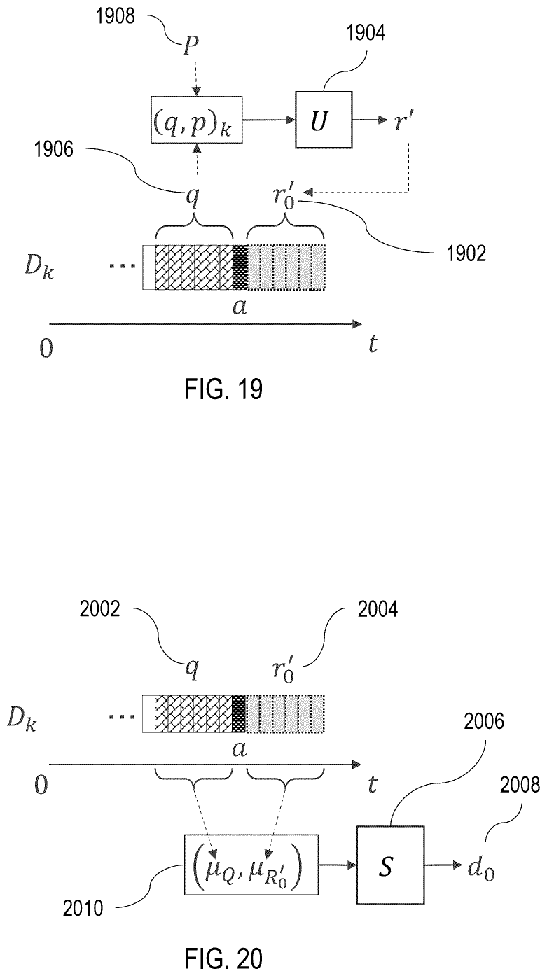

FIG. 19 illustrates example synthetic samples 1902 for drift duration prediction during an online stage, in accordance with illustrative embodiments. In view of the considerations discussed above, the present drift duration prediction is configured to leverage the sample synthesis model 1904 U. In particular, FIG. 19 illustrates that the present drift duration prediction is configured to obtain an initial set of r′₀ synthetic samples 1902 based on the q samples 1906 recently collected and an estimated path length 1908 P.

In example embodiments, the value of P can be predetermined based on a global statistic of the drifts in the domain, for example across the various edge nodes. In some embodiments, p can be determined to be the average path length in the domain, especially if there is low variance in the drift magnitudes. In alternative embodiments, other estimations may be more appropriate depending on the domain. For example, if abrupt drifts are critical to the domain application, then a low percentile, such as 5% or the like, can be used instead of the average. It is further appreciated that richer estimations of the drift path length can be used if available, as appropriate, without departing from the scope of the invention.

FIG. 20 illustrates an example drift duration prediction, in accordance with illustrative embodiments. With q and r′₀ samples 2002, 2004 in hand, the drift model 2006 S can be used to predict an estimated initial drift duration 2008 dₒ. This prediction includes leveraging the statistics 2010 of the inference confidence values μ_{R′}_{₀} of the initial set of synthetic samples r′₀. The inference confidence value μ_{Q} of the samples q is already obtained by the model M in its normal operation (see section B.3.1).

It is appreciated that this initial estimation 2008 of drift duration can be obtained as soon as drift is detected (e.g., at start time a), advantageously avoiding an undesired wait for actual samples past the initial drift identification.

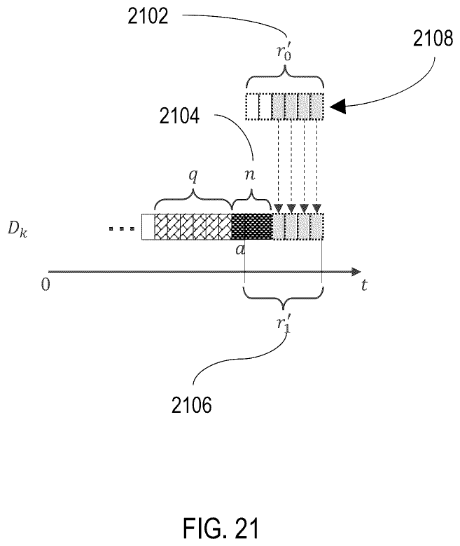

FIG. 21 illustrates example drift duration prediction using actual observed samples, in accordance with illustrative embodiments. As new actual samples r become available, they can be considered instead of the synthetic samples to refine the drift duration prediction. Example embodiments are configured to perform the following. Let r′ᵢ be the current set of synthetic samples (initially r′₀ 2102). As a number of n actual samples 2104 become available, the present drift duration prediction is configured to compose a new set of synthetic samples r′ᵢ₊₁ by discarding the first n samples of r′ᵢ and replacing them by the actual n samples obtained from the data stream Dₖ.

More particularly, FIG. 21 illustrates an example step in the iterative replacing of the samples in the synthetic set for actual samples 2104 observed in the stream Dₖ. In the example illustrated, the current set 2102 of synthetic samples, r′₀ is replaced by a newly composed set 2106 of synthetic samples r′₁ as two new samples become available.

The new set of synthetic samples r′ᵢ₊₁ is then used to obtain a new drift duration estimation, in similar fashion as described above. The process of replacing synthetic samples for observed samples can be repeated as required, up to on a sample-by-sample basis, as appropriate.

Advantageously, the sample synthesis mechanism described above allows for production of an anytime drift duration prediction or estimation. This “anytime” property means that as soon as drift is detected then a duration estimation can be obtained, and model management actions can be taken accordingly. As new samples become available, that estimation can be updated to more accurately reflect the baseline accuracy of the drift model S.

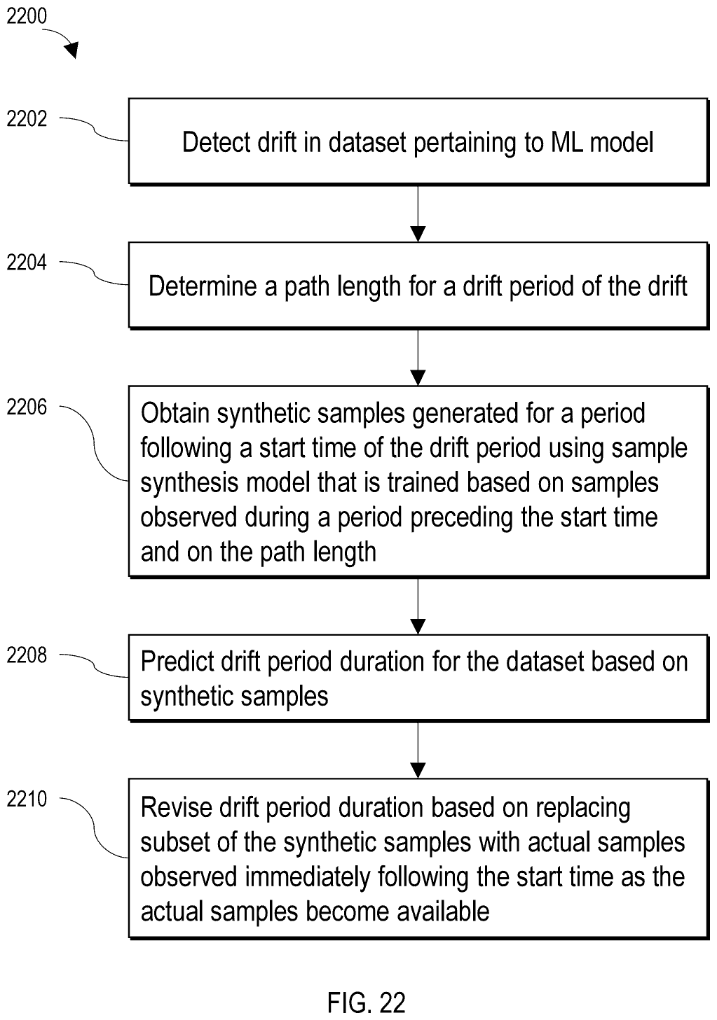

FIG. 22 illustrates a flowchart of an example method 2200 for predicting drift period duration, in accordance with illustrative embodiments.

In illustrative embodiments, the method 2200 includes steps 2202 through 2210. In some embodiments, these steps may be performed by the edge node. In alternate embodiments, these steps may be performed by the central node. In example embodiments, steps 2202 through 2206 may be associated with an offline phase (e.g., relating to training and deployment of a drift model trained to predict duration of drift periods using a sample synthesis model). Step 2208 may be further associated with an online phase (e.g., leveraging the sample synthesis model and drift model deployed at the edge node to predict a duration of a detected drift period).

In example embodiments, the method 2200 includes detecting a drift in a dataset pertaining to an ML-based model (step 2202). The drift can include a drift period that has a start time (a). The dataset can include a plurality of samples collected from a plurality of data streams received by a plurality of nodes, for example at the edge. The drift can be detected by determining whether a confidence score for one or more samples among the plurality of samples exceeds a predetermined threshold. Detecting the drift period can further include determining an end time for the drift period, and determining whether the confidence score for the one or more samples exceeds the predetermined threshold at any time between the start time and the end time.

In example embodiments, the method 2200 includes determining a path length for the drift period (step 2204). The path length can be determined based on determining an aggregate path length from the observed drift periods in a training dataset. The path length can comprise a period (z) following the start time (a). The period can be determined based on a magnitude of the drift. The magnitude can measure an amount of change in a distribution underlying the dataset (D). The magnitude can comprise a distance metric between a start time and an end time (t, t+m).

In example embodiments, the method 2200 includes obtaining synthetic samples generated for a period following the start time of the drift period (step 2206). The synthetic samples can be generated using a sample synthesis model (U) that is trained based on samples observed during a period preceding the start time, and based on the path length. The sample synthesis model (U) can comprise an artificial neural network or a recurrent neural network.

In example embodiments, the method 2200 includes predicting a drift period duration for the dataset based on the synthetic samples (step 2208). Predicting the drift period duration can comprise determining a first confidence value (μ_{Q}) based on the samples (q) observed during the period preceding the start time, determining a second confidence value (μ_{R},) based on the synthetic samples (r′) generated by the sample synthesis model (U), and estimating the drift period duration (d) using an ML-based drift model (S) that is trained based on the first and second confidence values. The model (M) can comprise a classifier model or a regression model. The drift model (S) can comprise a classifier model or a regression model.

In example embodiments, the method 2200 includes, in response to determining the drift period duration, managing the model (M). Managing the model can comprise retraining the model (M) using one or more newly observed actual samples to generate a new version of the model, and deploying the new version of the model (M) to an edge node.

In example embodiments, the method 2200 includes, upon observing one or more actual samples immediately following the start time (a), estimating an updated drift period duration (d) for the dataset (step 2210). More particularly, the method can further include replacing a subset of the synthetic samples with the actual samples as the actual samples are observed, to define an updated sample set for the period following the start time. The method can further include determining a subsequent second confidence value (μ_{R},) based on the updated sample set. The method can further include iteratively retraining the drift model (S) based on the first confidence value (μ_{Q}) and on the subsequent second confidence value (μ_{R},). The method can further include estimating an updated drift period duration (d) for the dataset using the drift model (S) that is iteratively retrained.

While the various steps in the example method 2200 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example method 2200 of FIG. 22 that any of the disclosed steps, processes, operations, methods, and/or any portion of any of these, may be performed in response to, as a result of, and/or, based upon, the performance of any preceding steps, process(es), methods, and/or, operations. Correspondingly, performance of one or more steps, processes, for example, may be a predicate or trigger to subsequent performance of one or more additional steps, processes, operations, and/or methods. Thus, for example, the various steps or processes that may make up a method may be linked together or otherwise associated with each other by way of relations such as the examples just noted. Finally, and while it is not required, the individual steps or processes that make up the various example methods disclosed herein are, in some embodiments, performed in the specific sequence recited in those examples. In other embodiments, the individual steps or processes that make up a disclosed method may be performed in a sequence other than the specific sequence recited.

As mentioned, at least portions of the present drift duration prediction system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories, and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

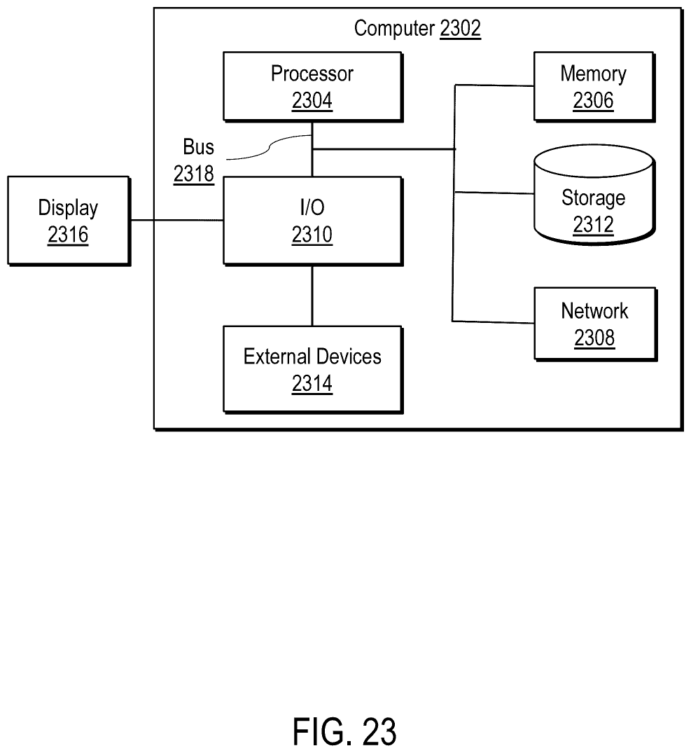

Illustrative embodiments of processing platforms will now be described in greater detail with reference to FIG. 23. Although described in the context of the system 100, these platforms may also be used to implement at least portions of other information processing systems in other embodiments.

FIG. 23 shows aspects of a computing device or a computing system in accordance with example embodiments. The computer 2302 is shown in the form of a general-purpose computing device. Components of the computer may include, but are not limited to, one or more processors or processing units 2304, a memory 2306, a network interface 2308, and a bus 2318 that communicatively couples various system components including the system memory and the network interface to the processor.

The bus 2318 represents one or more of any of several types of bus structures, including a memory bus or memory controller, a peripheral bus, an accelerated graphics port, and a processor or local bus using any of a variety of bus architectures. Example architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 2302 typically includes a variety of computer-readable media. Such media may be any available media that is accessible by the computer system, and such media includes both volatile and non-volatile media, removable and non-removable media.

The memory 2306 may include computer system readable media in the form of volatile memory, such as random-access memory (RAM) and/or cache memory. The computer system may further include other removable/non-removable, volatile/non-volatile computer system storage media. By way of example only, the storage system 2312 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 2318 by one or more data media interfaces. As has been depicted and described above in connection with FIGS. 1-22, the memory may include at least one computer program product having a set (e.g., at least one) of program modules that are configured to carry out the functions of the embodiments as described herein.

The computer 2302 may also include a program/utility, having a set (at least one) of program modules, which may be stored in the memory 2306 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 2302 may also communicate with one or more external devices 2314 such as a keyboard, a pointing device, a display 2316, etc.; one or more devices that enable a user to interact with the computer system; and/or any devices (e.g., network card, modem, mobile hotspot, etc.) that enable the computer system to communicate with one or more other computing devices. Such communication may occur via the input/output (I/O) interfaces 2310. Still yet, the computer system may communicate with one or more networks such as a local area network (LAN), a general wide area network (WAN), and/or a public network (e.g., the Internet) via the network adapter 2308. As depicted, the network adapter communicates with the other components of the computer system via the bus 2318. It should be understood that although not shown, other hardware and/or software components could be used in conjunction with the computer system. Examples include but are not limited to microcode, device drivers, redundant processing units, external disk drive arrays, Redundant Array of Independent Disk (RAID) systems, tape drives, data archival storage systems, etc.

### D. Further Discussion

Embodiments of the invention, such as the examples disclosed herein, may be beneficial in a variety of respects. For example, and as is apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

As disclosed herein, example embodiments may provide various useful features and advantages. For example, embodiments may provide model management opportunities based on characterizing drift at any time once drift is detected, avoiding a need to wait for additional samples to become available following initial detection of a drift.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

Specific embodiments have been described with reference to the accompanying figures. In the above description, numerous details have been set forth as examples. It will be understood by those skilled in the art that one or more embodiments may be practiced without these specific details and that numerous variations or modifications may be possible without departing from the scope of the invention. Certain details known to those of ordinary skill in the art have been omitted to avoid obscuring the description.

In the above description of the figures, any component described with regard to a figure, in various embodiments of the invention, may be equivalent to one or more like-named components described with regard to any other figure. For brevity, descriptions of these components have not been repeated with regard to each figure. Thus, each and every embodiment of the components of each figure is incorporated by reference and assumed to be optionally present within every other figure having one or more like-named components. Additionally, in accordance with various embodiments, any description of the components of a figure is to be interpreted as an optional embodiment, which may be implemented in addition to, in conjunction with, or in place of the embodiments described with regard to a corresponding like-named component in any other figure.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the invention should be limited only by the appended claims.

What is claimed is:

1. A system comprising:
at least one processing device including a processor coupled to a memory;
the at least one processing device being configured to implement the following steps:
detecting a drift in a dataset, the drift including a drift period having a start time, wherein the dataset pertains to a machine learning (ML)-based model;
determining a path length for the drift period;
obtaining one or more synthetic samples generated for a period following the start time using an ML-based sample synthesis model that is trained based on one or more samples observed during a period preceding the start time and on the path length for the drift period; and
predicting a drift period duration for the dataset based on the synthetic samples.

2. The system of claim 1, wherein predicting the drift period duration further comprises:
determining a first confidence value based on the samples observed during the period preceding the start time and a second confidence value based on the synthetic samples generated by the sample synthesis model; and
estimating the drift period duration using an ML-based drift model that is trained based on the first and second confidence values.

3. The system of claim 2, wherein the at least one processing device is further configured to implement the following steps:
upon observing one or more actual samples immediately following the start time:
replacing a subset of the synthetic samples with the actual samples as the actual samples are observed, to define an updated sample set for the period following the start time,
determining a subsequent second confidence value based on the updated sample set, and
estimating an updated drift period duration for the dataset using the drift model that is iteratively retrained based on the first confidence value and on the subsequent second confidence value.

4. The system of claim 2, wherein the model or the drift model comprises a classifier model or a regression model.

5. The system of claim 1, wherein the path length is determined based on determining an aggregate path length from the observed drift periods in a training dataset.

6. The system of claim 1, wherein the path length comprises a period following the start time, and the period is determined based on a magnitude of the drift.

7. The system of claim 6, wherein the magnitude measures an amount of change in a distribution underlying the dataset, and the magnitude comprises a distance metric between a start and an end time.

8. The system of claim 1, wherein the at least one processing device is further configured to implement the following step:
in response to predicting the drift period duration, managing the model.

9. The system of claim 8, wherein managing the model comprises:
retraining the model using one or more newly observed actual samples to generate a new version of the model, and
deploying the new version of the model to an edge node.

10. The system of claim 1, wherein the sample synthesis model comprises an artificial neural network.

11. A method comprising:
detecting a drift in a dataset, the drift including a drift period having a start time, wherein the dataset pertains to a machine learning (ML)-based model;
determining a path length for the drift period;
obtaining one or more synthetic samples generated for a period following the start time using an ML-based sample synthesis model that is trained based on one or more samples observed during a period preceding the start time and on the path length for the drift period; and
predicting a drift period duration for the dataset based on the synthetic samples.

12. The method of claim 11, wherein predicting the drift period duration further comprises:
determining a first confidence value based on the samples observed during the period preceding the start time and a second confidence value based on the synthetic samples generated by the sample synthesis model; and
estimating the drift period duration using an ML-based drift model that is trained based on the first and second confidence values.

13. The method of claim 12, further comprising,
upon observing one or more actual samples immediately following the start time:
replacing a subset of the synthetic samples with the actual samples as the actual samples are observed, to define an updated sample set for the period following the start time,
determining a subsequent second confidence value based on the updated sample set, and
estimating an updated drift period duration for the dataset using the drift model that is iteratively retrained based on the first confidence value and on the subsequent second confidence value.

14. The method of claim 12, wherein the model or the drift model comprises a classifier model or a regression model.

15. The method of claim 11,
wherein the path length is determined based on determining an aggregate path length from the observed drift periods in a training dataset, or
wherein the sample synthesis model comprises an artificial neural network.

16. The method of claim 11, wherein the path length comprises a period following the start time, and the period is determined based on a magnitude of the drift.

17. The method of claim 16, wherein the magnitude measures an amount of change in a distribution underlying the dataset, and the magnitude comprises a distance metric between a start and an end time.

18. The method of claim 11, further comprising, in response to predicting the drift period duration, managing the model.

19. The method of claim 18, wherein managing the model comprises:
retraining the model using one or more newly observed actual samples to generate a new version of the model, and
deploying the new version of the model to an edge node.

20. A non-transitory processor-readable storage medium having stored therein program code of one or more software programs, wherein the program code when executed by at least one processing device causes the at least one processing device to perform the following steps:
detecting a drift in a dataset, the drift including a drift period having a start time, wherein the dataset pertains to a machine learning (ML)-based model;
determining a path length for the drift period;
obtaining one or more synthetic samples generated for a period following the start time using an ML-based sample synthesis model that is trained based on one or more samples observed during a period preceding the start time and on the path length for the drift period; and
predicting a drift period duration for the dataset based on the synthetic samples.
